(19) United States
(12) Patent Application Publication
(10) Pub. No.: US 2020/0329676 A1
(43) Pub. Date: Oct. 22, 2020

(54) Compactable pet leash and harness

(71) Applicant: HFS Enterprises, Inc., Baltimore, MD (US)

(72) Inventor: Harold Sanchies, Baltimore, MD (US)

(21) Appl. No.: 16/823,598

(22) Filed: Mar. 19, 2020

Related U.S. Application Data
(60) Provisional application No. 62/836,862, filed on Apr. 22, 2019.

(51) Int. Cl. A01K 27/00

(52) U.S. Cl. CPC A01K 27/004; A01K 27/005; A01K 27/002

(57) ABSTRACT

The present invention is a compactable pet leash and harness assembly. The leash is segmented and contains a first handle at one end and a collar clip at the other end. The leash contains a second handle before the collar clip at the end of the leash segment containing the collar clip. The leash contains an accessory holder after the first handle at the end of the pet leash containing the first handle. A pair of clip buckles along the length of the pet leash between the accessory holder and the second handle allow for quickly shortening the leash. Two pairs of hook-and-loop type fasteners, or similar, along the length of the pet leash allow for attaching articles to the leash. A segment of elasticated strap allows limited lengthening of the leash in response to tension caused by the animal. The leash attaches to a quick disconnect harness having several attachment points allowing for gentle but effective control of the animal.

### CROSS REFERENCE TO RELATED APPLICATION

This application claims priority to Provisional patent application No. 62/836,862 filed on 22 Apr. 2019.

### FIELD OF THE INVENTION

The present invention relates generally to pet leashes and collars. More specifically, the present invention is a compactable leash and harness assembly that allows for gentle control of an animal.

### BACKGROUND OF THE INVENTION

Currently, much of present society own pets, such as dogs. A common, daily activity that many dog owners partake in is walking their dog. In walking their dogs, the pet owner has to secure a pet leash and a collar or harness to their dog. Although very useful in constraining the dog, most common pet leashes do contain some shortfalls. One primary shortfall is the inability for most common pet leashes to be easily compacted from a longer leash into a smaller leash. Although there are alternative pet leashes on the market that do allow for a dog owner to quickly extend and shorten the length of the pet leash with relative ease, these alternative pet leashes are often not sturdy enough in maintaining a shortened length of pet leash. This can be due to the recoil winder often employed on these alternative pet leashes, which can be overpowered by some dogs. Another shortfall of most common pet leashes is the attachment holder for containing, e.g., a poop bag. Because many dogs can be very excitable when being walked, the attachment holder for containing a poop bag that can be found on some common pet leashes is not sturdy enough to prevent the poop bag from being jostled about as the pet leash moves in response to the animal. This can result in the poop bag being dropped or dislodged from the attachment holder.

Pet harnesses are known in the art as a gentler and more effective way to control an animal, reducing the risk of choking and other injury to the animal. A known exercising device for animals, such as dogs, horses, and the like, comprises a harness for attachment to the chest region of the animal First and second leg bands are attached to the rear legs of the animal at its hocks, and an elastic cord interconnects these first and second leg bands with the harness through a pulley attached to the harness in the chest region of the animal. The length and tension of the elastic cord are selected to cause additional dynamic tension to be applied between the rear legs and the chest of the animal when the animal is walking and running, while at the same time permitting normal movement of the animal Thus, increased exercise and muscle build-up of the animal occurs under all conditions of exercise of such animal.

While generally effective, prior art harnesses suffer from some drawbacks. First, they tend to be difficult to quickly attach and disconnect from the animal. Also, they tend to have only one attachment point. Furthermore, even with adjustments they tend to sag, especially when the animal is in a sitting position. Finally, the position of the trainer relative to the animal cannot be adjusted, the trainer must walk either in front of or behind the animal.

An objective of the present invention is to provide a compactable pet leash and harness assembly. The leash can be easily made more compact or shortened to a firm and sturdy length and includes fasteners that maintain a shortened length regardless of whatever tension is being experienced by the device. The present invention intends to provide users with a pet leash that can better secure accessories and prevent the accessories from being dislodged from the pet leash, while the pet leash is in use or in motion. The leash is releasably attached to a harness that allows effective but gentle control over an animal. The harness includes several attachment points and can be quickly disconnected.

### SUMMARY OF THE INVENTION

The present invention is a compactable pet leash and harness assembly. The leash is segmented and contains a first handle at one end and a collar clip at the other end. The leash contains a second handle before the collar clip at the end of the leash segment containing the collar clip. The leash contains an accessory holder after the first handle at the end of the pet leash containing the first handle. A pair of clip buckles along the length of the pet leash between the accessory holder and the second handle allow for quickly shortening the leash. Two pairs of hook-and-loop type fasteners, or similar, along the length of the pet leash allow for attaching articles to the leash. A segment of elasticated strap allows limited lengthening of the leash in response to tension caused by the animal. The leash attaches to a quick disconnect harness having several attachment points allowing for gentle but effective control of the animal.

### BRIEF DESCRIPTION OF THE DRAWINGS

FIG. 1 is a top front perspective view of the leash of the present invention.

FIG. 2 is a bottom front perspective view of the leash.

FIG. 3 is a close-up, top front perspective view of a segment of the leash containing a first female buckle and a first male clip.

FIG. 4 is a close-up, bottom front perspective view of a segment of the leash containing a first female buckle, a first male clip, and a first fastener panel.

FIG. 5 is a close-up, top front perspective view of a segment of the leash containing a second fastener panel, a fourth fastener panel, and a second male clip.

FIG. 6 is a close-up, bottom front perspective view of a segment of the leash containing a third fastener panel and a second male clip.

FIG. 7 is a close-up, top front perspective view of a segment of the leash containing a cord and a second female buckle.

FIG. 8 is a close-up, bottom front perspective view of a segment of the leash containing a cord and a second female buckle.

FIG. 9 is a front perspective view of the harness of the assembly attached to an animal.

FIG. 10 is a side perspective view of the harness of the assembly attached to an animal.

FIG. 11 is a side perspective view of the harness of the assembly attached to an animal.

### DETAILED DESCRIPTION OF THE INVENTION

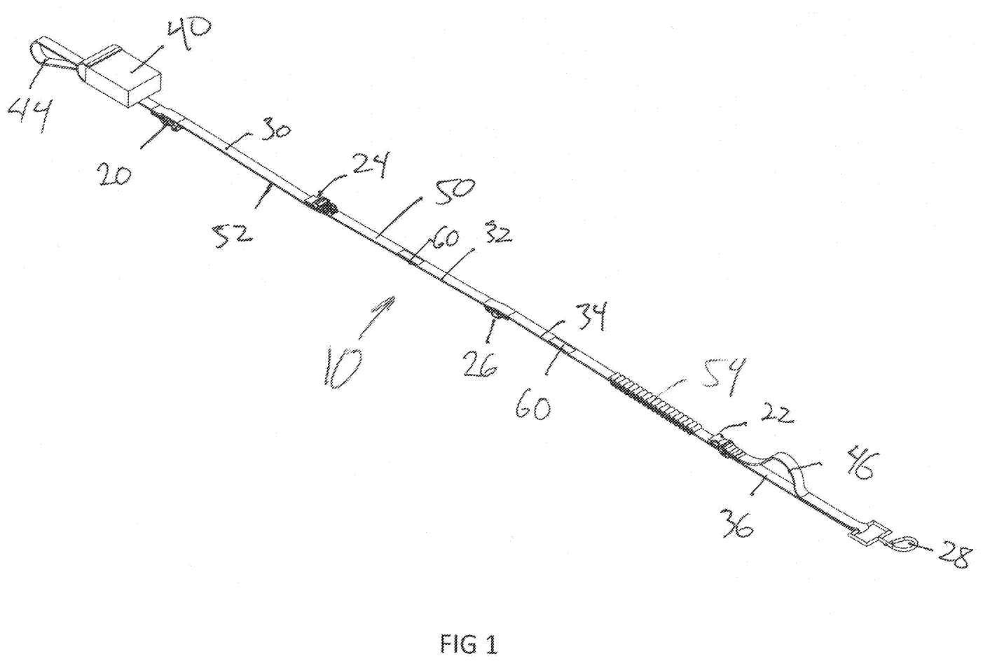

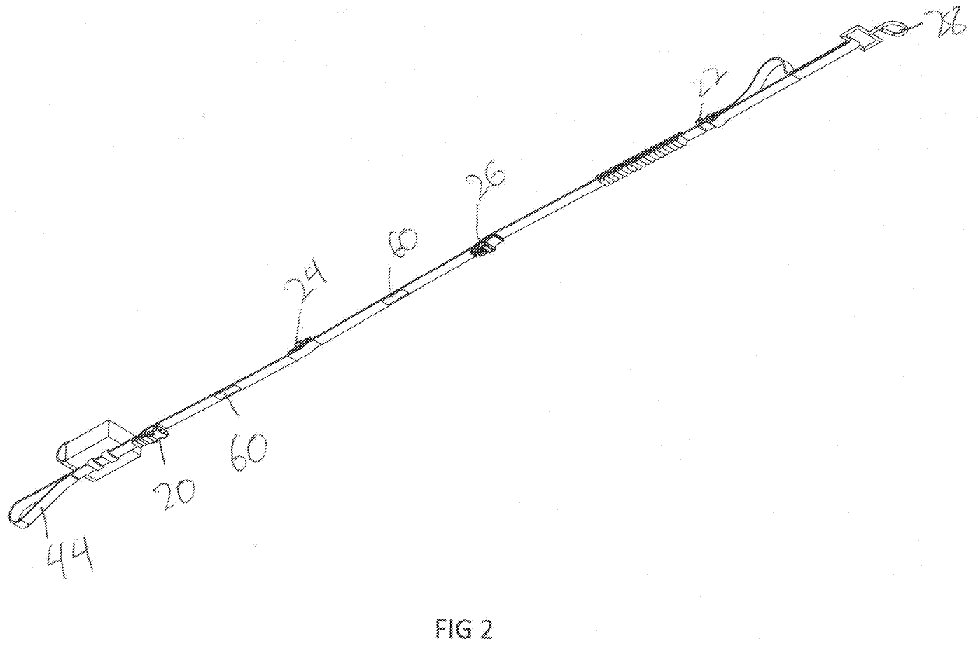

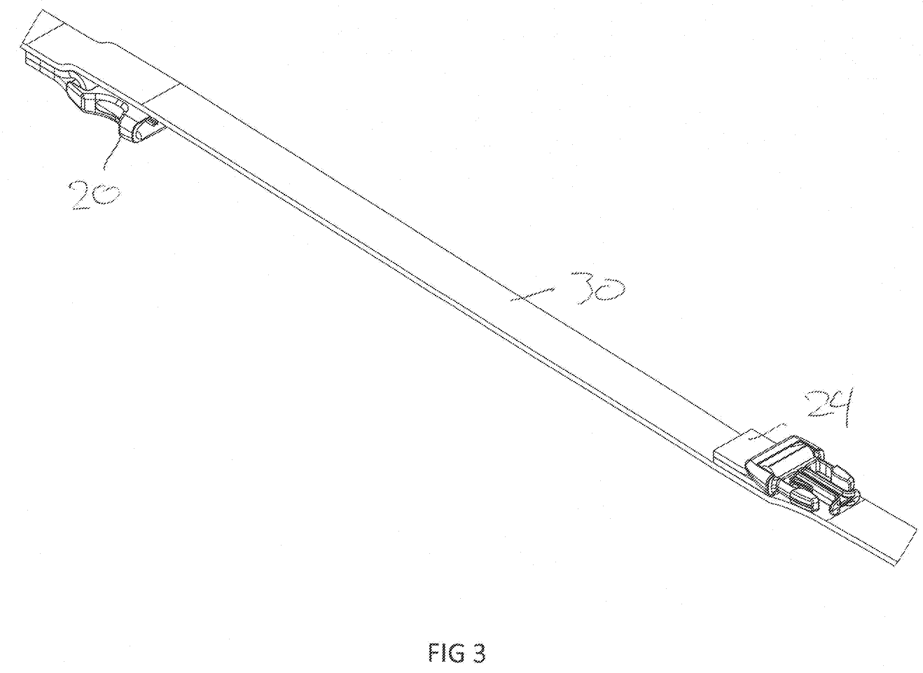

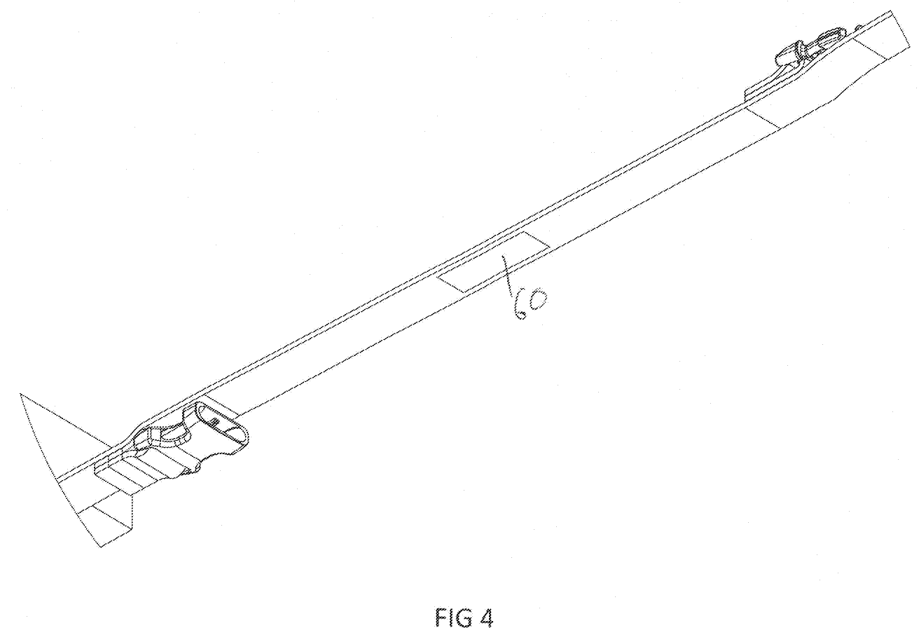

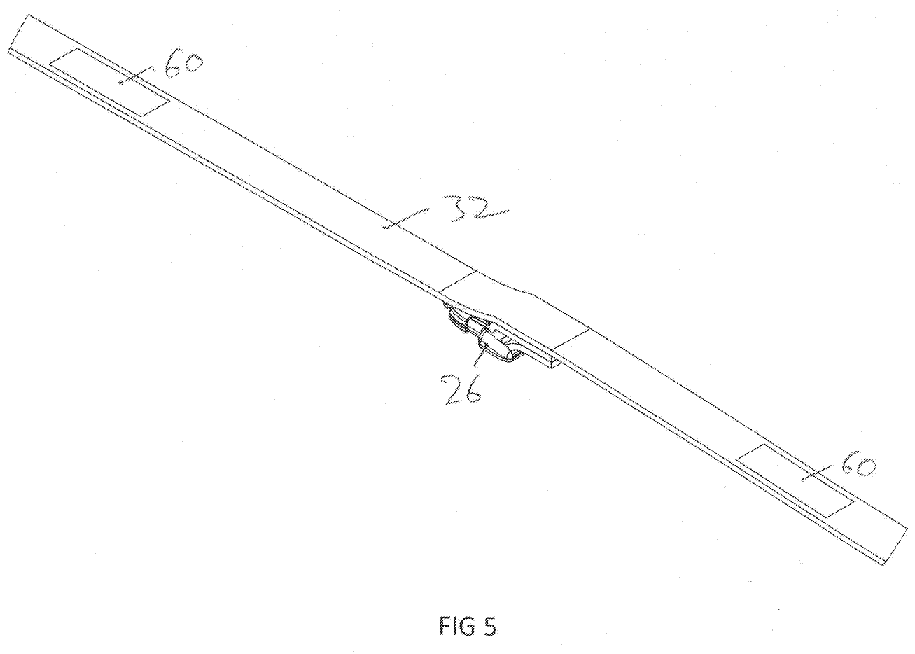

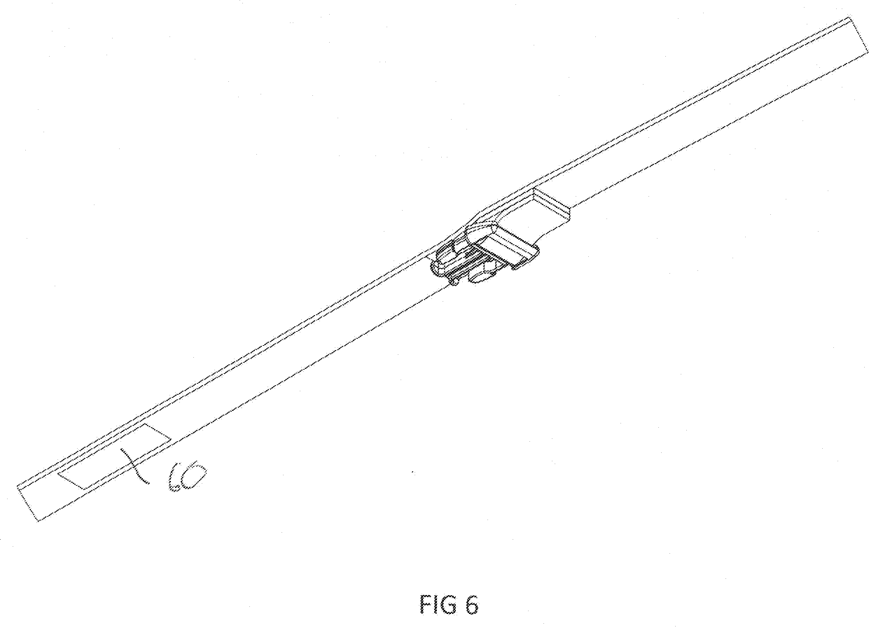

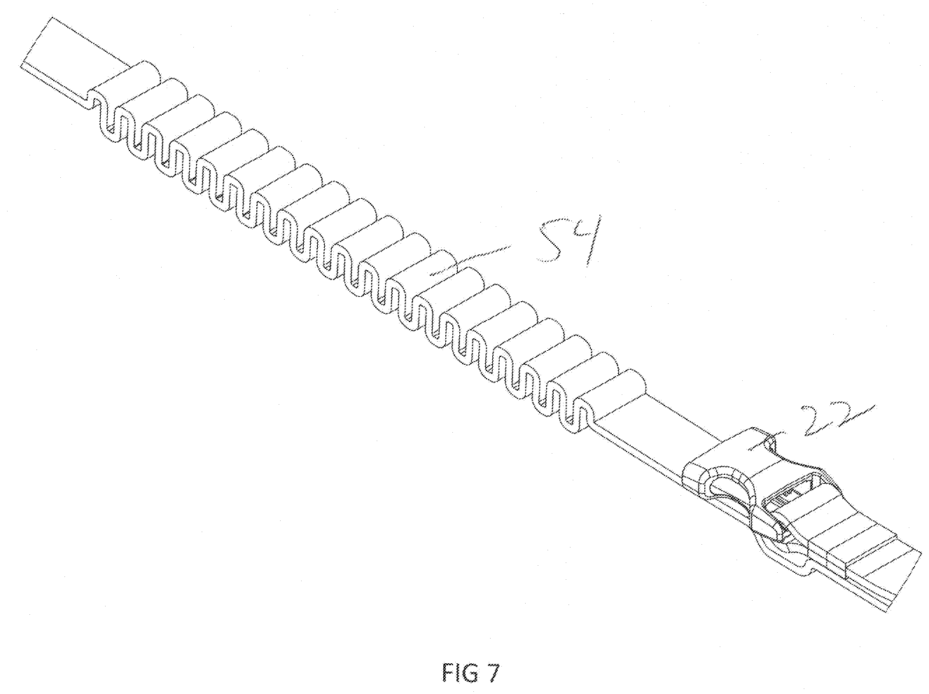

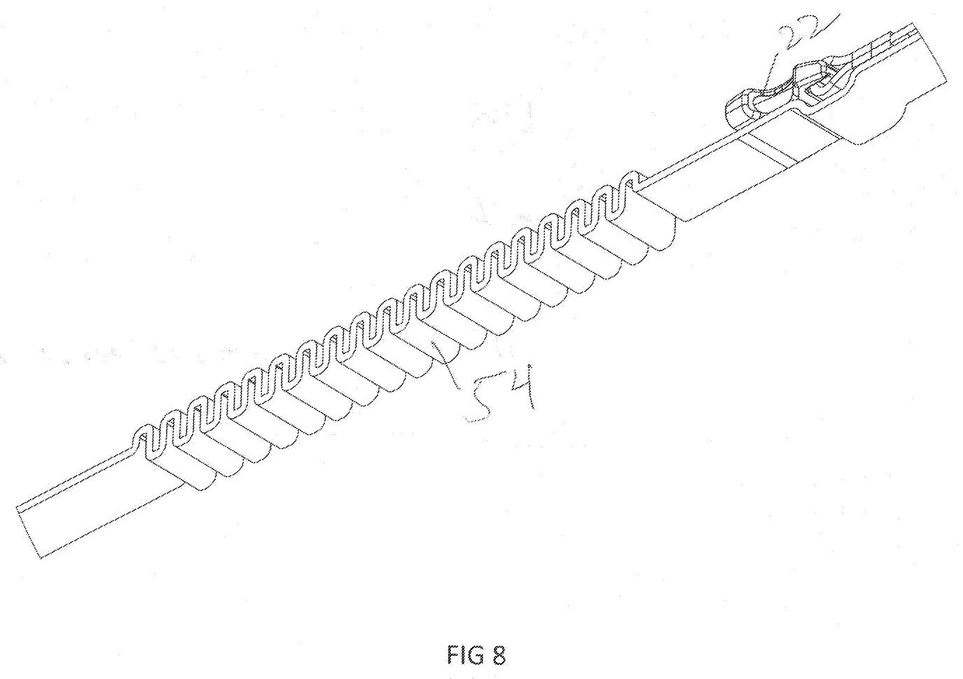

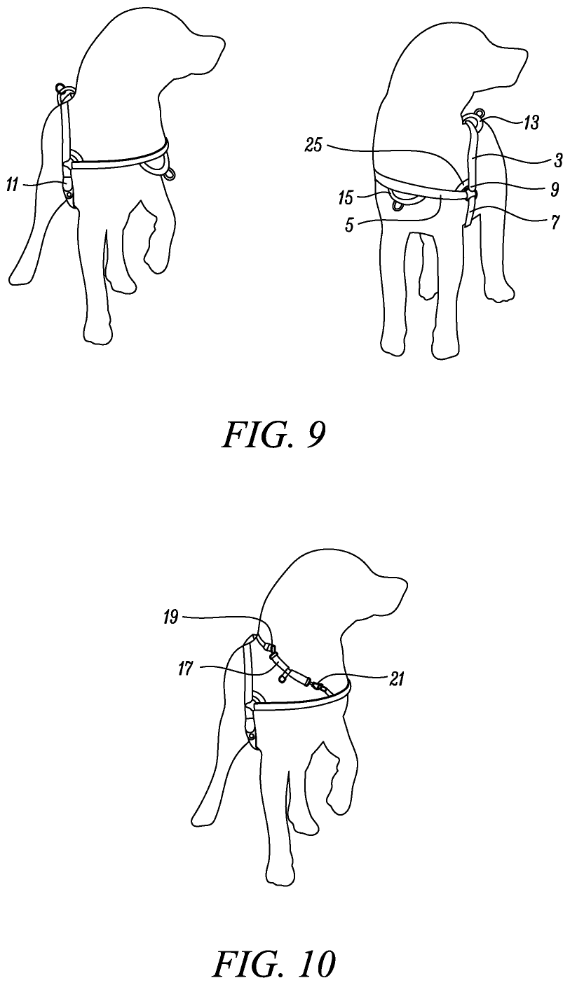

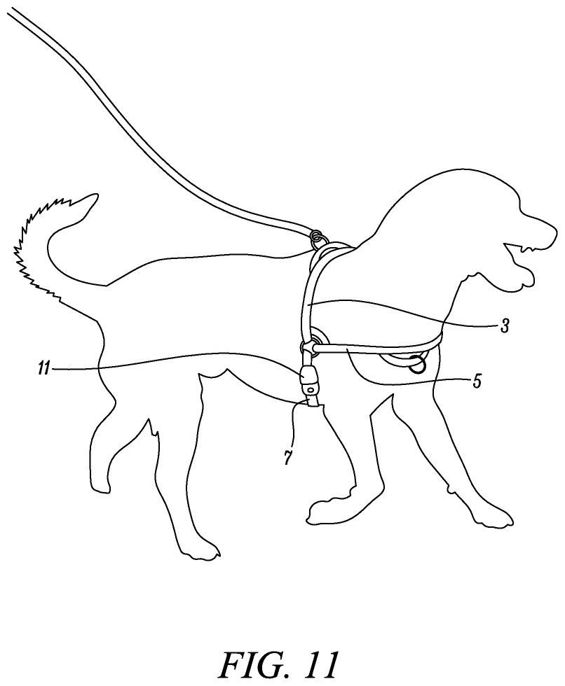

As seen in FIG. 1 through FIG. 11, the present invention is a compactable pet leash and harness assembly. It should be noted that the term compactable refers to a shortening of the leash as will be explained in more detail later. The leash 10 allows for quick and secure length adjustment to restrain a pet, while the harness 1 allows for effective but gentle control of a pet and includes a quick disconnect mechanism.

The leash and harness assembly may be of a material that is weather resistant, durable, tough, tear-resistant, flexible, and/or lightweight. By way of non-limiting example, the leash and harness assembly may be made of nylon or leather. The leash portion 10 of the assembly includes a first female buckle 20, a second female buckle 22, a first male clip 24, a second male clip 26, a collar clip 28, first through fourth fastener panels 30-36, and an accessory holder 40. Fastener panels 30-36 are joined by stitching or whatever means for joining is appropriate depending upon the material being used as would be apparent to one of skill in the art. The joined fastener panels form an elongated strap which comprises the main body of the leash 10. Collar clip 28 is connectable to a collar or harness as is known in the art.

A primary handle 44 and a restraint handle 46 are provided on the leash 10, the restraint handle 46 allowing for close restraint of a pet, especially for emergency situations. Accessory holder 40 can be used to contain any variety of small items generally associated with pet walking. In particular, accessory holder may contain a poop bag. It can be appreciated that holder 40 is situated close the controlling hand of the user and thus is not allowed to sway or move about as would an accessory holder positioned further away from the hand of the user on the leash 10.

Shortening the leash 10 involves the step of connecting the appropriate male clips to the appropriate female buckles. Particularly, it can be seen that the leash, and therefore each fastening panel 30-36 has an upper 50 and lower 52 side. Male clip 24 connects to female buckle 22 to shorten a long section of leash 10, which section includes the elasticated portion 54 of the leash 10. Male clip 26 connects to female clip 20 to shorten the leash 10, the elasticated portion 54 is then effectively bypassed to allow for more predictable and effective restraint of the animal. In an emergency, restraint handle 46 can be grasped, allowing the user to restrain the animal until either pair of shortening connectors can be utilized.

A series of hook or loop type patches 60 are disposed on both sides 50, 52 of panels 30-36 allowing for the attachment of accessories as would be apparent to one of skill in the art.

The harness 1 includes a shoulder strap 3, a chest strap (accent colored strap) 5, and a belly strap 7. The straps 3, 5, 7 are connected by way of rings 27 as is known in the art or alternatively by stitching. Chest strap 5 preferably is of a different color than the shoulder 3 and belly 7 straps to allow the user to properly orient the harness 1 when attaching to the pet. The straps 3, 5, and 7 are attached at one side of the pet by a “no-sag” joint 9 that keeps the chest strap 5 above the shoulder and on the other side (preferably the right side) by a quick-snap buckle 11 to allow removal. Buckle 11 has padding underneath to reduce discomfort to the animal. The no sag joint 9 is formed by a strip of material 25 connected between chest strap 5 and shoulder strap 3, the strip serving to maintain an approximately 45 degree angle between the two straps (5 and 7). It should be noted here that sagging of the harness can disturb the gait of the animal, ultimately resulting in injury. Each of the shoulder strap 3 and the chest strap 5 includes a tensioning control loop 13 or 15. A tensioning loop is a loop that increases pressure when a dog pulls. This pressure deters the dog from pulling without pressure or pain. A dual attachment apparatus 17, having a fastener 19 or 21 at either end and a fastener 23 in the middle for a leash, can be attached to the loops 13 and 15 for extra control of a strongly pulling dog.

The harness 1 can be used as follows. The harness 1 is placed on the pet so that the quick-snap buckle 11 is on the right side of the pet and the chest strap 5 is across the front of the pet's chest. The quick-snap buckle 11 is snapped into place. The leash 10 is attached to the loop 13 or 15 or to both by use of the dual attachment apparatus 17. When connected to the front loop 15 the user/trainer may walk in front of the animal, and if the animal does get too far ahead of the trainer, tension will cause the chest strap 5 to tighten about the animal's chest area and pull the animal to one side. Thus, front loop 15 is a tension control loop. When connected to the shoulder loop 13, the user can allow the animal to roam in front and more freely without engaging front loop 15. Connecting to both loops 13, 15 using dual attachment apparatus 17 allows for the most control of the animal as both control loops 13, 15 will provide tension and pull the animal to one side.

The invention in at least some embodiments promotes gentle and effective control and leadership of the dog. It safely discourages pulling and lunging behaviors. Straps 3, 5, and 7 may be reflective for night visibility, and can be neoprene-lined for softness, have exterior seams to prevent chafing, and can be easily put on and taken off via quick snap buckle 11.

Although the invention has been explained in relation to its preferred embodiment, it is to be understood that many other possible modifications and variations can be made without departing from the spirit and scope of the invention.

What is claimed is:

1. A compactable leash assembly comprising:
a series of fastener panels joined end to end to form an elongated strap, said series of panels including first, second, third, and fourth panels, each of said panels having upper and lower sides;
a primary handle formed at one end of said strap on said first panel and a collar clip formed at the opposing end, said collar clip extending from said fourth panel;
pairs of cooperating connecting members disposed on both upper and lower sides of said panels to form upper and lower connecting members;
whereby said leash may be shortened to one of two lengths by connecting a selected one of said pairs of cooperating connecting members.

2. The leash assembly of claim 1 wherein said fourth panel includes a secondary handle in close proximity to said collar clip.

3. A leash and harness assembly comprising:
a compactable leash formed of a plurality of joined fastener panels and associated connecting members, said connecting members allowing said leash to be shortened to one of two lengths, said leash including a primary and secondary handle;
a harness having a shoulder strap, a belly strap, and a chest strap, which straps are interconnected to fit about a torso of an animal;
said chest strap and said shoulder strap having control loops positioned thereon.

4. The leash and harness assembly of claim 3 wherein said leash may be alternatively connected to either said chest strap control loop and said shoulder strap control loop.

5. The leash and harness assembly of claim 3 wherein said leash is attached to both of said shoulder and chest control loops.

6. The leash and harness assembly of claim 3 including a dual attachment apparatus for connecting said shoulder and chest control loops.
